(19) United States
(12) Patent Application Publication
(10) Pub. No.: US 2021/0357535 A1
(43) Pub. Date: Nov. 18, 2021

(54) INTERACTIVE KIOSK WITH MISOPERATION PREVENTION FUNCTION

(71) Applicant: SHUTTLE INC., Taipei City (TW)

(72) Inventor: Hsiao-Hui LEE, Taipei City (TW)

(21) Appl. No.: 16/911,864

(22) Filed: Jun. 25, 2020

(30) Foreign Application Priority Data
May 15, 2020 (TW) 109116262

(51) Int. Cl. G06F 21/70; G06F 1/18; H05K 7/14

(52) U.S. Cl. CPC G06F 21/70; H05K 7/1427; G06F 1/181

(57) ABSTRACT

An interactive kiosk includes a machine body, a human-computer interaction interface, a magnetic induction module and a processing device. The machine body has an outer housing. The human-computer interaction interface is arranged on the machine body. The magnetic induction module and the processing device are disposed in the machine body. The processing device has a processing unit connecting to the human-computer interaction interface and the magnetic induction module. The magnetic induction module sends a magnetic induction signal to the processing unit by sensing a magnetic field of the magnetic object, and the processing unit receives the magnetic induction signal and controls the processing device to be started or shut down according to the magnetic induction signal.

### BACKGROUND OF THE INVENTION

### Field of the Invention

The present invention generally relates to an interactive kiosk, and more particular, to an interactive kiosk with misoperation prevention function.

### Description of Related Art

An interactive information service machine (Interactive kiosk, referred to as Kiosk) is used to provide information and application services of communication, business, entertainment or education etc.

Interactive kiosks are usually arranged in places with high flowrate of people and vehicles (such as shopping malls, hotel halls or airports, etc.) for people to use. They can provide self-services such as checking library collections, searching product information, providing door cards of hotels, depositing cash in exchange for merchandise or goods, and ordering merchandise or goods when they are out of stock . . . etc. Therefore, the interactive kiosks have been applied in many places.

However, the existing interactive kiosk is configured with a physical power switch, thus it is easy to be accidentally touched by people (especially children) other than engineering personnel, and that leads to the interactive kiosk to be shut down (OFF) inappropriately. As a result, it not only affects the use of other users, but also causes more or less damage to the machine itself.

Although the physical power switch can be locked in the interactive kiosk to avoid accidental touch. But in this way, the engineering personnel must carry special keys at all times, and the interactive kiosk must be unlocked with the special key to operate the physical power switch. It is extremely troublesome and inconvenient apparently of using.

### SUMMARY OF THE INVENTION

Accordingly, an object of the present invention is to provide interactive kiosk with misoperation prevention function, which can prevent mistouch of start and shut down by mistake.

In order to achieve the object mentioned above, the present invention provides an interactive kiosk with misoperation prevention function for using with a magnetic object. The interactive kiosk comprises a machine having an outer housing, and the outer housing has a plurality of sides. A human-computer interaction interface is arranged on the machine body. A magnetic induction module is disposed in the machine body and neighbors one of the plurality of sides. A processing device is disposed in the machine body and has a processing unit, and the processing device is connected to the human-computer interaction interface and the magnetic induction module; wherein, the magnetic induction module sends a magnetic induction signal to the processing unit by sensing a magnetic field of the magnetic object; and the processing unit receives the magnetic induction signal and controls the processing device to be started or shut down according to the magnetic induction signal.

Comparing to the prior art, the present invention has the following effects. The interactive kiosk of the present has the effect of misoperation prevention of start and shut down of the interactive kiosk.

### BRIEF DESCRIPTION OF DRAWINGS

The features of the invention believed to be novel are set forth with particularity in the appended claims. The invention itself, however, may be best understood by reference to the following detailed description of the invention, which describes a number of exemplary embodiments of the invention, taken in conjunction with the accompanying drawings, in which:

FIG. 1 is a perspective schematic view of a front side of a first embodiment of the interactive kiosk of the present invention.

FIG. 2 is a perspective schematic view of a rear side of a first embodiment of the interactive kiosk of the present invention.

FIG. 3 is a plan schematic view of a rear side of first embodiment of the interactive kiosk of the present invention.

FIG. 4 is a plan schematic view of a lateral side of a first embodiment of the interactive kiosk of the present invention.

FIG. 5 is a circuit block diagram of a first embodiment of the interactive kiosk of the present invention.

FIG. 6 is a perspective schematic view of a back side of a second embodiment of the interactive kiosk of the present invention.

### DETAILED DESCRIPTION OF THE PREFERRED EMBODIMENTS

In cooperation with attached drawings, the technical contents and detailed description of the invention are described thereinafter according to a number of preferable embodiments, not being used to limit its executing scope. Any equivalent variation or modification made according to appended claims is all covered by the claims claimed by the present invention.

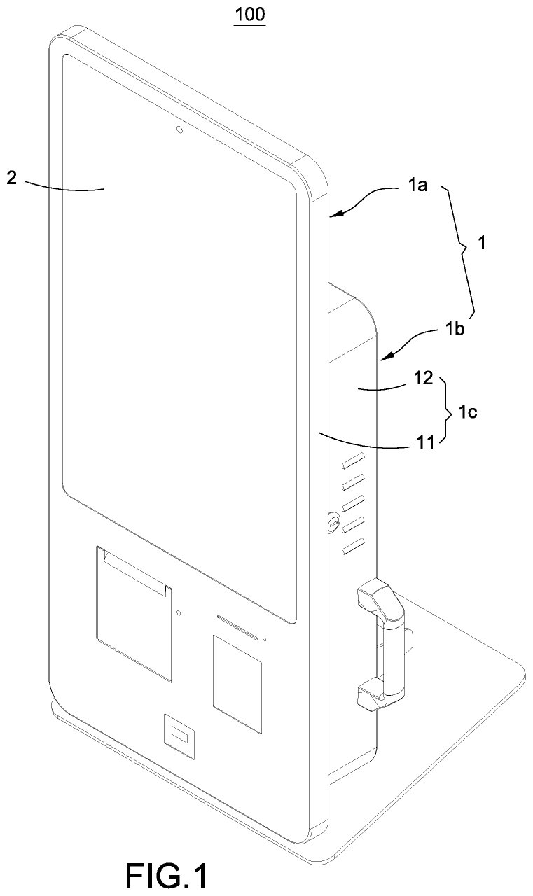

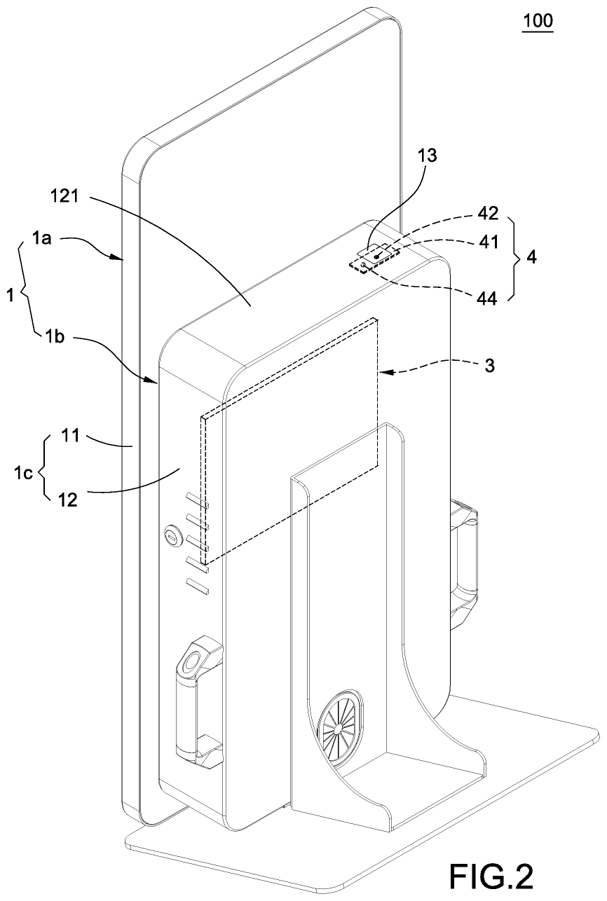

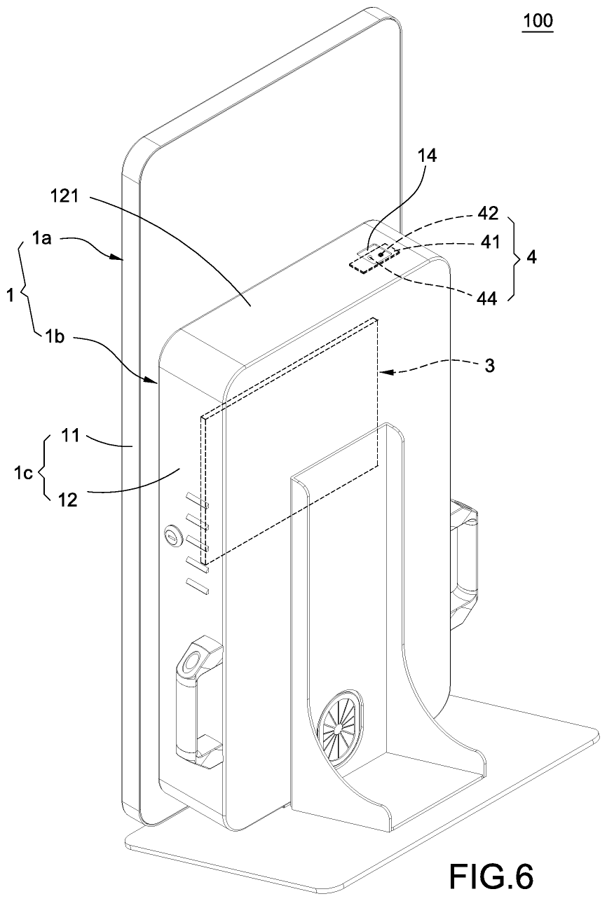

Please refer to FIG. 1 and FIG. 2. The present invention provides an interactive kiosk with misoperation prevention function (hereinafter referred to as interactive kiosk 100) which can prevent people (especially children) from accidentally touching existing physical power switches and lead to an improperly shut down. The first embodiment is shown in FIG. 1 to FIG. 5, and the second embodiment is shown in FIG. 6.

As shown in FIG. 1 and FIG. 2, a first embodiment of the interactive kiosk 100 of the present invention includes a machine body 1, a human-computer interaction interface 2, a processing device 3 and a magnetic induction module 4.

The machine body 1 includes a plate 1a and a host 1b disposed on the back of the plate 1a. The plate 1a has a plate shell 11, and the host 1b has a host shell 12. The plate shell 11 and the host shell 12 are combined to constitute the housing 1c of the machine body 1. In other words, the housing 1c of the machine body 1 includes the plate shell 11 and the host shell 12.

The plate shell 11 and the host shell 12 both have a plurality of sides. With regard to which sides are included in the plurality of sides, since the present invention does not limit specific shapes of the plate shell 11 and the host shell 12, it is not limited to which sides are included. In the present invention, the plate shell 11 has a cuboid shape, thus the plurality of sides of the plate shell 11 includes a front side, a rear side, a left side, a right side, an upper side and a lower side. The host shell 12 also has a cuboid shape, thus the plurality of sides of the host shell 12 includes a rear side, a left side, a right side, an upper side 121 and a lower side.

The human-computer interaction interface 2 can be any interactive interface that provides users to interact with the interactive kiosk 100, and the present invention is not limited thereto. In the present embodiment, a touch screen is taken as an example for description. As shown in the figure, the human-computer interaction interface 2 is disposed inside the plate 1a and exposed at the front side of the plate shell 11 to facilitate touch operation of users.

The magnetic induction module 4 is disposed in the body 1 and is close to the inner wall surface of the casing 1c from the inside to facilitate performing a magnetic induction. The present invention does not limit where the magnetic induction module 4 is arranged in the body 1, nor does it limit which side is close to the housing 1c. For example, the magnetic induction module 4 can be disposed in the plate 1a and is close to the front side of the plate shell 11 (not shown in the figure), or it can be disposed in the host 1b and is close to the rear side of the host shell 12 (not shown in the figure). In the present embodiment, the magnetic induction module 4 is arranged in the host 1b as shown in FIG. 2 and is close to the upper side 121 of the host shell 12.

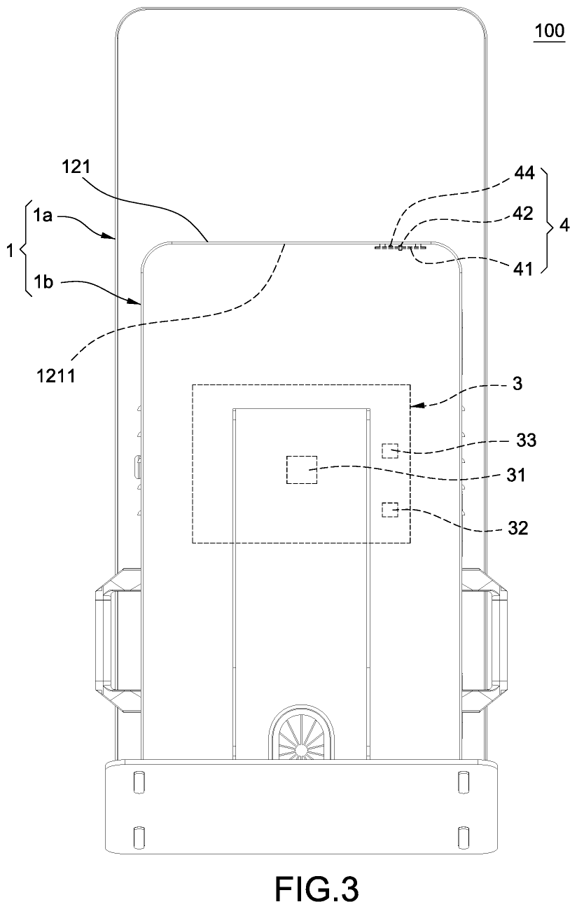

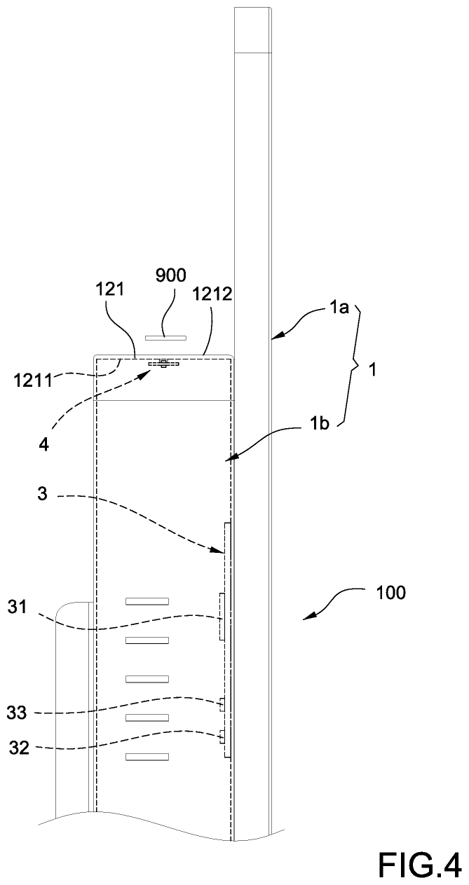

In more detail, as shown in FIG. 3 and FIG. 4, the magnetic induction module 4 includes a circuit board module 41 and a magnetic induction element 42. The magnetic induction element 42 is an element capable of sensing a magnetic field, and the magnetic induction element 42 is disposed on the circuit board module 41, so that the magnetic induction element 42 is electrically connected to the circuit board module 41. The fixing of the magnetic induction module 4 is achieved by fixing the circuit board module 41 to the inner wall surface 1211 of the upper side 121, but the invention is not limited thereto.

As shown in FIG. 3 to FIG. 5, the processing device 3 is disposed in the machine body 1, but it is not limited to where it is installed in the machine body 1. For example, the processing device 3 can be disposed on the outer wall surface (not shown) of another side of the host shell 12. In the present embodiment, the processing device 3 is disposed in the host 1b and has a processing unit 31.

The processing device 3 of the present invention does not limit to a specific device. For example, the processing device 3 can be a computer (not shown). In the present embodiment, a motherboard as shown is taken as an example for description, and the processing unit 31 is electrically connected to the motherboard. Moreover, the processing unit 31 can also be a central processing unit (CPU) disposed on the motherboard and electrically connected thereto.

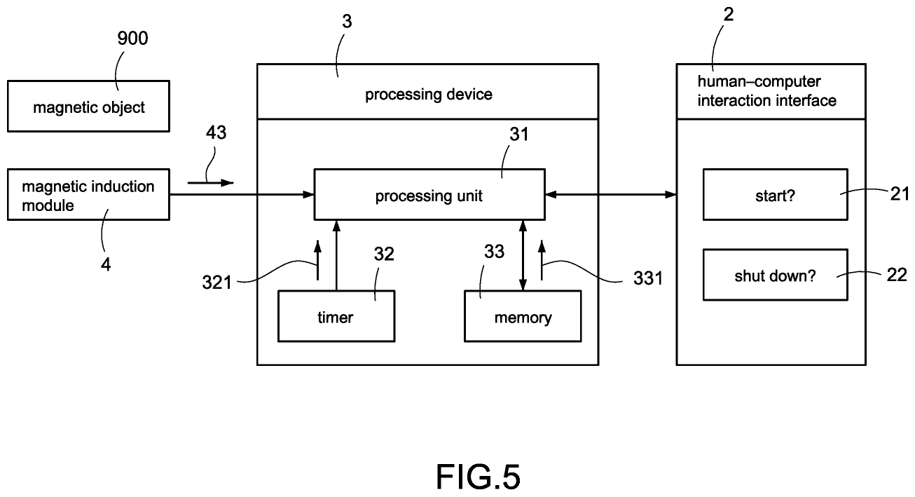

As described above, as shown in FIG. 5, the human-computer interaction interface 2 and the magnetic induction module 4 are connected (including physical connection and electrical connection) to the processing unit 31 separately.

Thereby, as the interactive kiosk 100 of the present invention has replaced the existing physical power switch with the magnetic induction and electronic control to achieve the start (ON) or shut down (OFF), thus it can prevent all people (especially children) except the local engineering personnel from accidentally touching the existing physical power switch. In brief, it has an effect of misoperation prevention of start and shut down of the entire interactive kiosk 100. However, the start and shut down of the interactive kiosk 100 of the present invention still can be achieved through designs of magnetic induction and electronic control. The details are as follows.

When the local engineer wants to start or shut down the interactive kiosk 100 of the present invention, as long as any magnetic object 900 that can generate a magnetic field is held and corresponds to the magnetic induction module 4 in a non-contact manner outside the host shell 12, then the magnetic induction element 42 can sense the magnetic field generated by the magnetic object 900 (not shown). The magnetic induction module 4 will send a magnetic induction signal 43 to the processing unit 31 when the magnetic induction element 42 senses a magnetic field. After the magnetic induction signal 43 is received and confirmed by the processing unit 31, the processing device 3 is controlled to be started or shut down, and then the interactive kiosk 100 of the present invention will start or shut down respectively.

It is worth of noticing that, the magnetic object 900 can be a magnet, an electromagnet, or any object with a magnet or an electromagnet. For example, since the mobile phones are all provided with speakers, and the speakers have magnets or electromagnets, thus the 1 local engineering personnel can use a mobile phone (provided as a magnetic object 900) as a key to start or shut down the interactive kiosk 100.

The interactive kiosk 100 of the present invention to be started or shut down can be further selected by local engineering personnel except the above controlling method. As shown in FIG. 5, after the processing unit 31 receives the magnetic induction signal 43, it can further send a start option 21 and a shutdown option 22 displayed on the human-computer interaction interface 2 according to the magnetic induction signal 43 for the local engineering personnel to choose to start or shut down the processing device 3 by touch.

As shown in FIG. 4 and FIG. 5, in order to strengthen the restriction that only local engineering personnel can perform the operation of start and shut down by various magnetic objects 900, the processing device 3 can further have a timer 32 and preferably a memory 33, and the memory 33 has provided with a preset induction time 331. Thereby, when the magnetic induction element 42 senses a magnetic field, the timer 32 counts the time which the magnetic induction element 42 has sensed the magnetic field as to generate a magnetic induction time 321. After the processing unit 31 receives the magnetic induction time 321, the processing unit 31 compares the magnetic induction time 321 with the preset induction time 331 accessed from the memory 33. When the processing unit 31 determines that the magnetic induction time 321 is equal to or approximately equal to the preset induction time 331, the processing device 3 is controlled to be started or shut down; otherwise, the start or shut down will not be performed. In other words, if an uninformed person holds a magnet and continues sensing the magnetic induction module 4 for an induction time more than or less than the preset induction time 331, the processing unit 31 will determine that it is not equal to the preset induction time 331, and the start or shut down will not be performed.

Furthermore, in order to remind the local engineering personnel that the magnetic induction element 42 has sensed a magnetic field, a prompt element 44 can be provided and electrically connected to the circuit board module 41, so that the prompt element 44 can output sound, light, or sound and light (sound or/and light) for a period of time as a reminder when the induction element 42 has sensed the magnetic field. Preferably, the prompt element 44 can also have another use. It can let the local engineering personnel themselves to control the induction time not more than or less than the preset induction time 331 through the sound or light of the prompting element 44.

The prompting element 44 can be any element capable of emitting sound (such as a buzzer, etc.) or any element capable of emitting light (such as LED, etc.).

Moreover, as shown in FIG. 2 to FIG. 4, since the magnetic induction module 4 of the first embodiment is hidden in the housing 1c of the machine body 1, in order to remind the local engineering personnel about the exact position of the magnetic induction module 4, a prompt graphic 13 (which can be patterns, symbols or texts) can be added on the outer wall surface 1212 of the host shell 12 (see FIG. 4) corresponding to the location of the magnetic induction module 4, so that the magnetic object 900 can accurately correspond to the magnetic induction module 4 to perform a magnetic induction. It should be noted that, when the magnetic induction module 4 is hidden in the housing 1c, the aforementioned prompting element 44 must emit sound for prompting.

FIG. 6 is a second embodiment of the interactive kiosk 100 of the present invention. The second embodiment is substantially the same as the first embodiment, and the only difference is that the prompt graphic 13 of the first embodiment is changed to an opening 14 of the second embodiment, so that the engineering personnel can see the magnetic induction element 42 and the prompt element 44 disposed in the machine body 1 through the opening 14. Since the prompting element 44 can be seen, the prompting element 44 can emit light for prompting. However, in other embodiments not shown in the figures, a transparent body can be embedded in the opening 14 to transmit the light emitted from the prompting element 44 through the transparent portion of the transparent body, and even a prompt graphic 13 can be added outside the transparent body.

In summary, the interactive kiosk with misoperation prevention function indeed achieves the intended purposes to solve the lack of previous technology. Thus, the present invention fully meets the requirements of patent to file the application in accordance with the Patent Law. Please research and grant the present invention to protect the rights of the inventor.

Although the present invention has been described with reference to the preferred embodiment thereof, it will be understood that the invention is not limited to the details thereof. Various substitutions and improvements have been suggested in the foregoing description, and others will occur to those of ordinary skill in the art. Therefore, all such substitutions and improvements are intended to be embraced within the scope of the invention as defined in the appended claims.

What is claimed is:

1. An interactive kiosk with misoperation prevention function provided for using with a magnetic object, comprising:
a machine body having an outer housing, and the outer housing having a plurality of sides;
a human-computer interaction interface arranged on the machine body;
a magnetic induction module disposed in the machine body and neighboring one of the plurality of sides; and
a processing device disposed in the machine body and having a processing unit, and the processing device connected to the human-computer interaction interface and the magnetic induction module;
wherein, the magnetic induction module sends a magnetic induction signal to the processing unit by sensing a magnetic field of the magnetic object; and the processing unit receives the magnetic induction signal and controls the processing device to be started or shut down according to the magnetic induction signal.

2. The interactive kiosk with misoperation prevention function according to claim 1, wherein the processing device further includes a timer having a preset induction time; the timer counts time which the magnetic induction module has sensed the magnetic field as to generates a magnetic induction time; the processing unit receives the magnetic induction time to compare with the preset induction time; and the processing unit controls the processing device to be started or shut down by determining that the magnetic induction time is equal to the preset induction time.

3. The interactive kiosk with misoperation prevention function according to claim 1, wherein the magnetic induction module has a prompt element, and the magnetic induction module activates the prompting element to output sound, light or sound and light for a period of time by sensing the magnetic field of the magnetic object.

4. The interactive kiosk with misoperation prevention function according to claim 2, wherein the magnetic induction module has a prompt element, and the magnetic induction module activates the prompting element to output sound, light or sound and light for a period of time by sensing the magnetic field of the magnetic object.

5. The interactive kiosk with misoperation prevention function according to claim 1, wherein the processing unit can further send a start option and a shutdown option displayed on the human-computer interaction interface according to the magnetic induction signal for selecting to start or shut down the processing device after receiving the magnetic induction signal.

6. The interactive kiosk with misoperation prevention function according to claim 1, wherein one of the plurality of sides of the outer housing has an outer wall surface, and the outer wall face has a prompt graphic corresponding to a location of the magnetic induction module.

7. The interactive kiosk with misoperation prevention function according to claim 1, wherein one of the plurality of sides of the outer housing has an opening corresponding to a location of the magnetic induction module, and the magnetic induction module is seen through the opening.

8. The interactive kiosk with misoperation prevention function according to claim 1, wherein the magnetic induction module is hidden in the outer housing.

9. The interactive kiosk with misoperation prevention function according to claim 1, wherein the magnetic induction module senses the magnetic field generated by the magnetic object outside the outer housing and sends the magnetic induction signal.

10. The interactive kiosk with misoperation prevention function according to claim 1, wherein the magnetic induction module includes a circuit board module and a magnetic induction element provided for sensing the magnetic field, and the magnetic induction element is disposed to electrically connect to the circuit board module.

11. The interactive kiosk with misoperation prevention function according to claim 10, wherein the circuit board module is fixed on an inner wall surface of one of the plurality of sides.

12. The interactive kiosk with misoperation prevention function according to claim 1, wherein the processing device is a motherboard; the processing unit is a central processing unit (CPU); and the central processing unit is disposed to electrically connect with the motherboard.
